(19) United States
(12) Patent Application Publication
(10) Pub. No.: US 2017/0337334 A1
(43) Pub. Date: Nov. 23, 2017

(54) Systems and Methods of Generating Medical Billing Codes

(71) Applicant: Epiphany Cardiography Products, LLC, Midlothian, VA (US)

(72) Inventors: James Stanczak, Arlington, IL (US); Russell Deremer, Midlothian, VA (US); Alan Risse, Camarillo, CA (US); Eddie Hernandez, Hialeah Gardens, FL (US)

(21) Appl. No.: 15/598,264

(22) Filed: May 17, 2017

Related U.S. Application Data
(60) Provisional application No. 62/337,497, filed on May 17, 2016.

(51) Int. Cl. G06F 19/00; G06Q 30/04

(52) U.S. Cl. CPC G06F 19/328; G06F 19/322; G06Q 30/04

(57) ABSTRACT

A method for coding clinical input data by a charge capture system comprises the steps of receiving clinical input data from a clinical input data source, the clinical input data including interpretations of measured data; providing one or more coding algorithms; dividing the interpretations of measured data into phrases; and processing the phrase through a pattern matcher that matches one or more elements of the phrase to an initial code. The method further includes the steps of processing the initial codes to generate a corresponding one or more billing codes; if more than one billing code is determined, ranking the billing codes in an order of significance to determine a highest ranked billing code; and providing one of the one billing code and the highest ranked billing code to a billing system.

### CROSS-REFERENCE TO RELATED APPLICATIONS

This application incorporates by reference and claims the benefit of priority to U.S. Provisional Patent Application No. 62/337,497 filed May 17, 2016.

### BACKGROUND OF THE INVENTION

The present subject matter relates generally to a charge capture system that automatically generates billing codes based on patient files and physician notes. More specifically, the present invention relates to a charge capture system that utilizes natural language processing to convert manual interpretation notes written by a physician into medical codes used for submission of bills for reimbursement of medical procedures to public and private insurers.

When a patient has any medical exam or procedure, the hospital or medical facility must communicate the work performed to the patient's public or private insurer in order to receive payment. Generally, to receive reimbursement, hospitals must document claims using medical code sets that communicate information about the patient, procedures performed, diagnoses that were made, etc., in a uniform manner. Medical classification, or medical coding, is the process of transforming descriptions of medical diagnoses and procedures into universal medical code numbers. The diagnoses and procedures are usually taken from a variety of sources within the healthcare record, such as the transcription of the physician's notes, laboratory results, radiology results, and other sources.

Medical insurance billers and coders are tasked with coding a patient's diagnosis along with a request for payments from the patient's insurer. Accurately coding a patient in clinical documentation is important to reduce compliance risks, minimize a healthcare facility's vulnerability to fraud claims during external audits, provide insight into legal quality-of-care issues, and to ensure correct payment.

Presently, a medical coder must examine physician's notes and the patient's medical files by hand in order to determine the appropriate billing code(s) and enter the code(s) into a billing system for the benefit of creating the “Superbill.” After reading the physician's notes and the patient file, the medical coder must enter in billing codes one at a time. In order to do so, the medical coder must understand the medical procedures performed during each individual patient encounter and be familiar with the corresponding billing codes. Moreover, upon diagnosis, there are individual diagnosis medical billing codes that must also be generated.

Additionally, there are different types of medical billing codes, some of which may be required for medical services rendered to patients that are hospitalized (inpatient) while others may be required for patients that are not hospitalized (outpatient). Further, certain types of medical billing codes must be generated for Medicare and other types of medical billing codes for Medicaid patients. Adding even further complexity to the process, there might be terms, acronyms, and abbreviated comments in the patient's file or in the physician's notes that the medical coder may not be familiar with as the medical lexicon is vast. Accordingly, the medical coder spends quite a bit of time completing this task for each patient file, costing the hospital time and labor costs.

The complexity and difficulty of medical coding creates room for human error. The impact has been made more profound due to the change from ICD-9 codes (˜13,000) to ICD-10 codes (˜68,000). The manual process lends itself to mistakes that may cause:
a.) a payer to reject a reimbursement/payment;
b.) delays in a hospital or medical facility receiving payment for services rendered as claims are submitted, rejected, and resubmitted, etc.;
c.) incomplete and/or reduced payment when the billing code(s) submitted does/do not meet the billing and coding guidelines or correspond to a reason why the medical procedure was ordered, as specified by the Centers for Medicare & Medicaid Services (“CMS”); and/or
d.) insufficient payment if a billing code submitted does not meet the highest clinical significance when there is be a billing code with a higher severity that can be used.

Latest trends in healthcare show an increasing demand on physicians and clinical personnel to do some medical coding. Physicians are directly tasked with having to enter medical billing codes when ordering laboratory and diagnostic tests as well as performing other, more complex levels of medical coding. They have little or no in-depth experience with this task. They are not medical coding experts and this task likely imposes a burden on their time and effort in researching and selecting the appropriate medical billing codes from set tables and medical coding reference guides.

Accordingly, there exists a need for a computerized system that automatically generates billing codes based on patient files and physician notes.

### BRIEF SUMMARY OF THE INVENTION

To meet the needs described above and others, the present disclosure provides a charge capture system that automatically generates billing codes based on patient files (e.g., patient demographics, order information, and diagnosis) and physician notes. The charge capture system receives machine-level interpretation statements (such as those generated by a digital medical device, like an electrocardiograph) and manual interpretation notes written by a physician or other healthcare provider, and generates medical codes used for submission of bills for reimbursement of medical procedures to public and private insurers.

The charge capture system enables a healthcare provider, such as a hospital or clinic, to automate the process of generating medical codes used for submission of bills for reimbursement of medical procedures to public and private insurers. These codes are used by facilities when completing the Superbill and the respective medical claim form(s) used to obtain payment from Medicare, Medicaid, and private insurance companies.

The charge capture system assists medical coders who have a need for a software solution that enhances productivity by automatically suggesting CPT, ICD-9, and ICD-10 procedural and diagnosis codes. With the charge capture system, a skilled medical coder spends less time with manual review of paper and electronic medical documents in determining the appropriate procedure and diagnosis.

An advantage of the invention is that it provides a charge capture system that reduces need for physicians to be medical coding experts by gathering study data directly from ECG devices with confirmed interpretations; it performs real-time, automatic scans to provide ICD-9 and ICD-10 codes.

Another advantage of the invention is that it provides a charge capture system that generates codes instantly rather than by a manual process requiring a medical coder to look-up medical terminology, abbreviations, and medical lexicons using extensive reference guides and coding books.

A further advantage of the invention is that it provides a charge capture system that enables quicker reimbursements, an improved revenue cycle, reduces work to be performed by medical coders, ensures accuracy of information, and prioritizes codes based on clinical significance. During the project management and deployment phase of the product, custom changes are made to input and output methods and configurations are made to suit the inbound and outbound requirements of the medical facility.

In one example, a facility may be interested in placing HL7 order information files on a secure shared folder on the network, and to receive the outbound (result) file via a secure TCP connection. To utilize these preferences, configuration changes to the format and contents of the outbound HL7 file and custom designation of the segment(s) used to transmit the individual medical billing codes generated by the charge capture system may be necessary. Script changes may be needed to adjust the algorithm to comply with specific requirements of a facility. In one embodiment, a facility may configure the charge capture system to custom map certain medical codes based on individual criteria. For example, the charge capture system coded the interpretive statement of “Non-ST elevation (NSTEMI) myocardial infarction” assigns an ICD-10 code of “121.4.” 121.4 is a specific ICD-10 code that can be used to specify a diagnosis and can be submitted to receive reimbursement. Because this same code can be applied to various other non-ST myocardial infarction conditions, the facility in this case may configure the charge capture system to code the interpretive statement of “Non-ST elevation (NSTEMI) myocardial infarction” with an ICD-10 code of “121.3” to more accurately reflect that this is an acute case, since this medical facility deals primarily with acute medical cases. Just as with 121.4, this alternate code is a specific ICD-10 code that can be used to specify a diagnosis and can be submitted to receive reimbursement.

Yet another advantage of the invention is that it provides a charge capture system that enables hospitals to bill for the tests upon completion of a procedure rather than waiting until the patient has been discharged.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of a charge capture system of the present application.

FIG. 2 is a schematic representation of the various functions that may be provided by the charge capture system of FIG. 1.

FIG. 3 is an example user interface of the charge capture system of FIG. 1.

FIGS. 4 and 5 illustrate example of interpretive notes received by the charge capture system of FIG. 1.

FIG. 6 is a flowchart illustrating an example method of automatically generating medical billing codes using the charge capture system of FIG. 1.

### DETAILED DESCRIPTION OF THE INVENTION

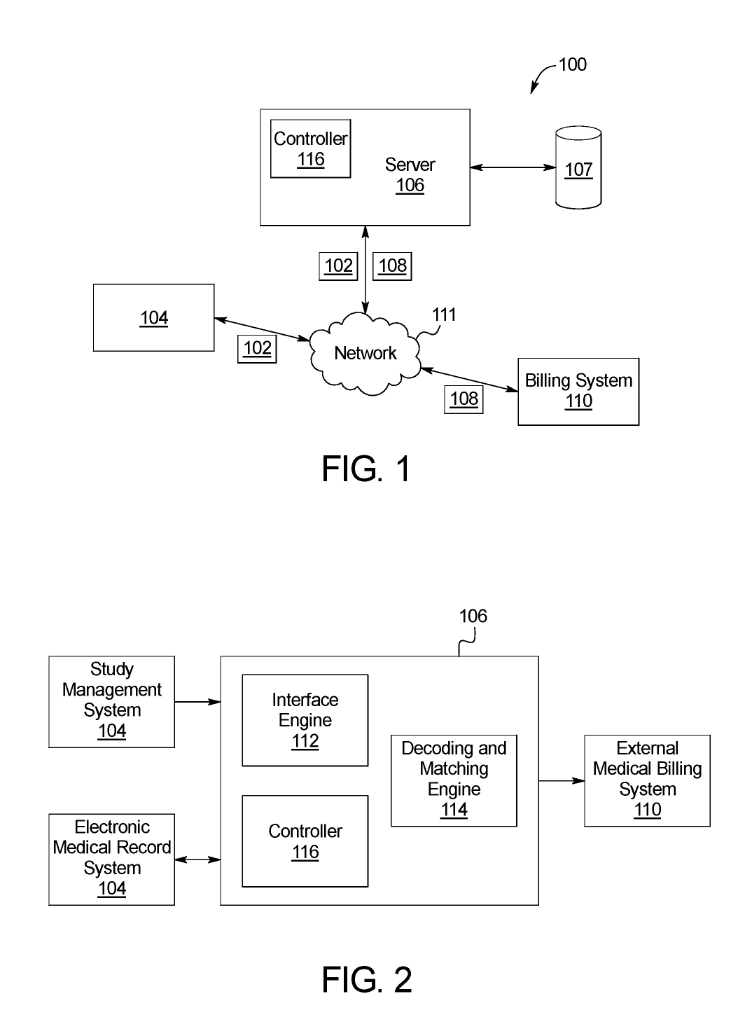

FIGS. 1 and 2 illustrate an example of a charge capture system 100. The charge capture system 100 receives input data 102 from one or more input data sources 104, analyzes and processes the input data 102 on a charge capture server 106, and generates medical codes 108 that are provided to the billing system 110 and may be used for submission of bills for reimbursement of medical procedures to public and private insurers. The charge capture server 106 communicates with a database 107 that stores medical code information. The charge capture system 100 enables a healthcare institution or facility, such as a hospital or clinic, to automate the generation of medical codes 108 used for submission of bills for reimbursement of medical procedures to public and private insurers. These codes are used by facilities when completing the Superbill and the respective medical claim form(s) used to obtain payment from Medicare, Medicaid, and private insurance companies.

The input data sources 104 may include a diagnostic study management system, an electronic medical records (EMR), a health information system, or interpretive notes provided by the healthcare provider, or any other source for providing a description of medical procedures used to treat a patient. The input data 102 may be directed by a user or may be provided automatically to the charge capture server 106 through a network 112 upon entry from the data source 104. Through the network 112, the charge capture system 100 provides an interactive website through which the healthcare provider may share input data 102 and authorize the sending of medical billing codes 108.

As used herein, input data 102 may refer to one or more of the following: free text, normalized pre-selected text, pre-loaded interpretive statements, macros, favorites, and voice recognition notes. Free text may include comments entered manually by a physician using a standard keyboard or input source. Normalized pre-selected text may include words or portions of words typed into a diagnostic study management system, such as Cardio Server by Epiphany Healthcare, that automatically provides a list of corresponding statements or descriptions for the healthcare provider to select. The diagnostic study management system may be a part of the charge capture system 10 or may be provided separately and operate in conjunction with the charge capture system. Pre-loaded interpretive statements may include those statements that may be automatically populated from a set table of statements. For example, using a study management system, a physician can select statements from a lookup table by category/type or they can utilize a search feature to help them find a particular statement(s). These lookup table statements may be provided as normalized pre-selected text.

The study management system may also provide macros including pre-defined phrases that are easy to input and therefore act as a shortcut. In one example, a physician may enter a macro for an interpretive statement in all capital letters followed by a space bar into a diagnostics study management system, and the diagnostics study management system automatically replaces the macro with a pre-loaded statement or a statement from a table corresponding to the macro. The pre-loaded statement or lookup table statement may be provided in the form of normalized pre-selected text. Within the diagnostics study management system, a user may select one or more pre-loaded interpretive statements as “favorites”, and may be verbiage that is used frequently by the user, stored in the system to improve productivity and shorten the time involved in doing a repetitive task.

The charge capture system 100 may begin by receiving electronic orders for medical procedures, commonly referred to as an Admission Discharge Transfer message (“ADT”) or a Health Level-7 (“HL7”) message. Once the medical procedure has been completed, the healthcare provider may annotate and confirm the test results of the medical procedure through the data input sources 104 such as an EMR or an HIS. The charge capture server receives this input data 102 for processing.

FIG. 2 illustrates the various functions that may be provided by the charge capture system 100. In the illustrated embodiment, the server 106 of the charge capture system 100 includes an interface engine 112 and a decoding and matching engine 114. While the embodiment of the charge capture system 100 shown in FIG. 2 is presently the preferred embodiment, it is contemplated that various versions of the charge capture system 100 may include a greater or lesser number of management tools and engines that will be apparent to those skilled in the art based on the disclosure provided herein. It is further understood that while the various tools are expressed as independent elements within the example of the charge capture system 100 shown in FIG. 2, such separation is provided for simplification and clarity of the description and it is known that the various tools may be overlapping, fully integrated, or otherwise interrelated, as will be understood by those skilled in the art.

In an embodiment, the charge capture server 106 includes software stored in a non-transitory, computer memory that may be run on a controller 116. The interface engine 112 of the charge capture system 100 communicates with various data input sources 104 such as EMR, EHR, HIS, and diagnostic study management systems, all at the end-users' preference. In some embodiments, the interface engine 112 may be a general-purpose, off-the-shelf software solution that coordinates messaging between various hospital information systems. The interface engine 112 may be integral with the charge capture system 100 or be a separate device in communication with the charge capture system 100.

The interface engine 112 may be used to convert data from one format to another, such as transforming between XML and HL7. The interface engine 112 may also manipulate the data in order for data to be easily transferred between systems. For example, the interface engine 112 may add leading zeros to a patient identification (ID) number so that the ID number is accepted by another system, or the interface engine 112 may reformat the date from mm/dd/yyyy to yyyy-mm-dd as necessary. The charge capture system 100 may use algorithms and logic to scan the input data 102, including electronic machine- and human-generated interpretation notes from the healthcare provider and/or institution.

The interface engine 112 allows the charge capture system 100 to receive input data 102 regardless of the source 104. In one embodiment, the charge capture system may utilize a platform called Mirth Connect, although any platform interface engines may be used. The interface engine 112 is configured to receive HL7 messages from various hospital sources of input data 102 such as electronic medical records databases, study management systems , or order management systems. For example, input data 102 for a single patient or procedure may come from a number of data input sources 104 including an HL7 2.x data source, an HL7 3.x data source, a DICOM data source. Additionally, the interface engine 112 supports a wide variety of formats including various message types and options such that the charge capture system can access any and all data available in an incoming message.

The charge capture system 100 may store the input data 102 in an incoming data table in a relational database 107 in communication with the server 106. The charge capture system 100 may create and define an XML data dictionary that is populated by the interface engine 112. In some embodiments, the interface engine 112 converts the input data 102 into a format for use by the controller 116 of the charge capture system 100. In an embodiment, the interface engine 112 may be configured and customized to receive input data 102 using a particular hospital's message format.

Using the configuration, the interface engine 112 may populate an XML data dictionary and place the XML data dictionary into the relational database 107. The controller 116 of the charge capture system 100 may periodically check the incoming data table for newly arriving data dictionaries. When a new data dictionary is found, the controller 116 may read the dictionary from the relational database 107 and label the record as “processed”. The charge capture system 100 may be configured to control this polling interval, although a typical interval is five seconds. The data dictionary may be passed to one or more coding algorithms. Each coding algorithm processes the data dictionary and may emit zero, one, or more charge codes. Coding algorithms may be included for: ICD-9-CM—ICD-9 diagnostic codes, ICD-10-CM—ICD-10 diagnostic codes, CPT 2015—CPT procedure codes, ICD-9-PCS—ICD-9 procedure codes, and ICD-10-PCS—ICD-10 procedure codes.

In an embodiment, the decoding and matching engine 114 parses through the text of the input data 102 to find common verbiage and abbreviations for specific medical terminology to identify a diagnosis or diagnoses. The decoding and matching engine 114 then matches the diagnosis or diagnoses to corresponding medical billing code(s) based on a pre-defined table of medical classification codes including the Current Procedural Terminology (CPT) codes established by the American Medical Association and the 9^{th} and 10^{th} revisions of the International Statistical Classification of Diseases and Related Health Problems (ICD-9 and ICD-10, respectively) codes established by the World Health Organization. Specifically, the decoding and matching engine 114 references a plurality of stored medical codes stored on the database 107 and/or server 106. In some embodiments, each diagnosis from the input data 102 is first matched to an initial code, which is then matched to a billing code.

Each algorithm may contain a specific logic for generating codes. In some embodiments, algorithms that generate procedure codes may be simple and rather trivial. For example, procedure code algorithms may simply look for one or more properties in the data dictionary and generate the procedure code. For example, if the data dictionary indicates the study is an electrocardiographic (“ECG”) result, this maps to specific CPT 2015 and ICD-9-PCS and ICD-10-PCS procedure codes. Each algorithm can be independently enabled or disabled via configuration options. For example, a hospital may only be interested in ICD-10 codes so the ICD-9-CM and ICD-9-PCS algorithms could be disabled in this scenario. Algorithms may also be configured to emit a special <nocode> value to indicate the algorithm was unable to generate a code for the specified data dictionary. The <nocode> value allows for a positive notification that data was processed despite no codes being generated, based on the available information.

The billing codes generated by the various algorithms may be gathered and stored in an output codes table on the server 106 and/or database 107. The interface engine 112 may read the output codes table and forward the billing codes to the appropriate hospital information systems, such as the electronic medical records system 104 or the billing system 110. The interface engine 112 may process the outbound database table containing the generated codes and transmit a message to the hospital containing these codes. The generated codes may contain the following information: the code type, the billing code(s), the confidence level of each code, and a clinical ranking of the code(s).

Code types may include such codes as “ICD-9-CM”, “ICD-10-CM”, “CPT 2015”, etc. The billing code is a code of the code type selected by the algorithm, such as “145.1”, “426.10”, “93000”, etc. The confidence level is a scaled quantitative value, such as a number on a confidence scale of 1 to 5. An algorithm may determine a confidence level to a high degree of accuracy, such as between 0% to 100%, and the algorithm may then bin the codes into a smaller confidence scale such as a scale of 1 to 5, which may be easier for the user to understand. When ranking is required, the algorithm ranks the codes on a comparative scale, so that the code with rank 1 is considered the highest clinical priority over other potential codes ranked 2 or 3.

The interface engine 112 may use as much or as little of this information as deemed by the user. For example, the user may configure the charge capture system 100 so that it sends only receive the highest ranked code for each coding, instead of sending all codes. The user may also configure the charge capture system 100 to disregard any code having a low confidence level as set by the user.

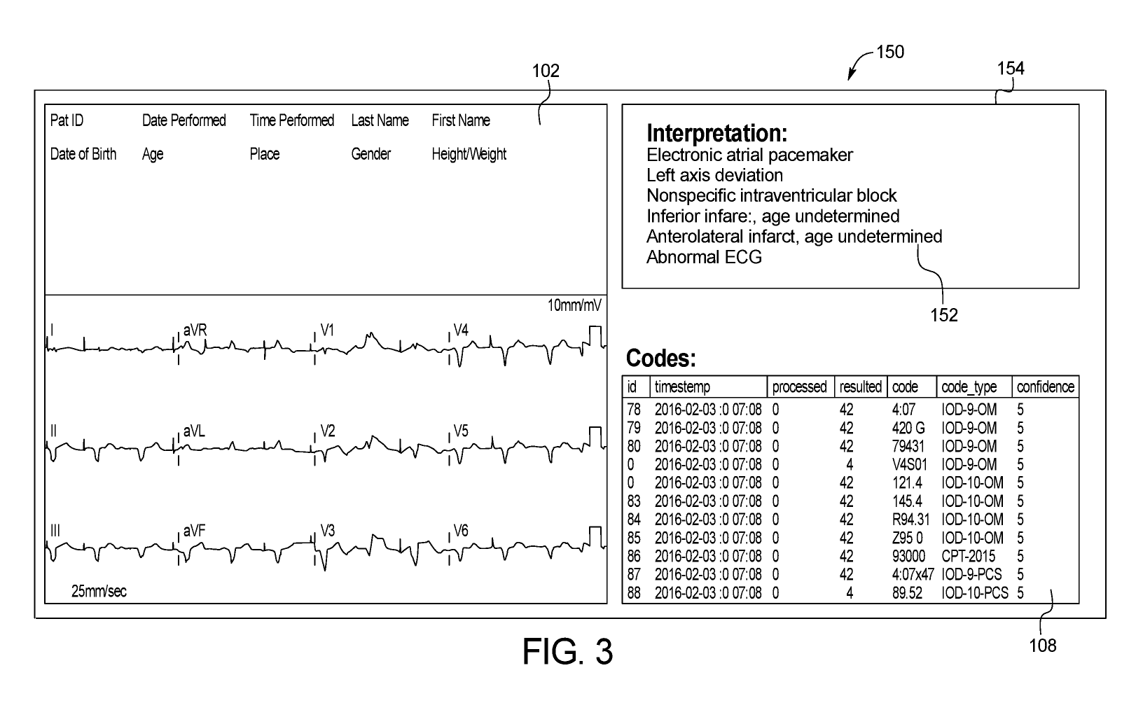

In an embodiment, the charge capture system may include an ICD-9-CM algorithm and an ICD-10-CM algorithm that generate diagnosis codes using a rules-based expert system with fuzzy logic matching. The majority of information used to determine the diagnosis and/or initial code (if applicable) may be retrieved from the study field as shown in FIG. 3 and as described below. The study field is a free text field that may be edited by a physician and may include interpretations, statements, or physician's notes, etc.

FIG. 3 illustrates a user interface 150 of the charge capture system 100. When tasked to perform coding, a healthcare provider or other user reviews an ECG using the ECG review system and inputs a group of interpretation notes 152 in a freeform text box or study field 154. The charge captures system 100 then processes the input data 102 and the interpretation notes 152 to generate corresponding classification codes 108. The charge capture system 100 then sends the classification codes 108 to the electronic medical record database 104 and/or billing system 110 associated with the healthcare provider, the insurer, and the patient.

In one embodiment, the code generation method performed by the charge capture system 100 may include the steps of parsing the interpretation notes 152 into phrases, performing fuzzy-logic matching of words and word combinations in each phrase to possible initial codes, optionally matching the initial codes with procedural codes, and, once the codes are generated, apply expert-systems logic to match the initial or procedural codes with billing codes.

Although a phrase can often be as simple as a single sentence, determining exactly where one phrase ends and another begins is not straightforward because interpretations often lack proper sentence punctuation. An algorithm of the charge capture system 100 examines punctuation characters, word casing (i.e., whether a word begins with a capital letter), and statistics gathered from a large body of studies that computes word pairing probabilities to determine where phrases begin.

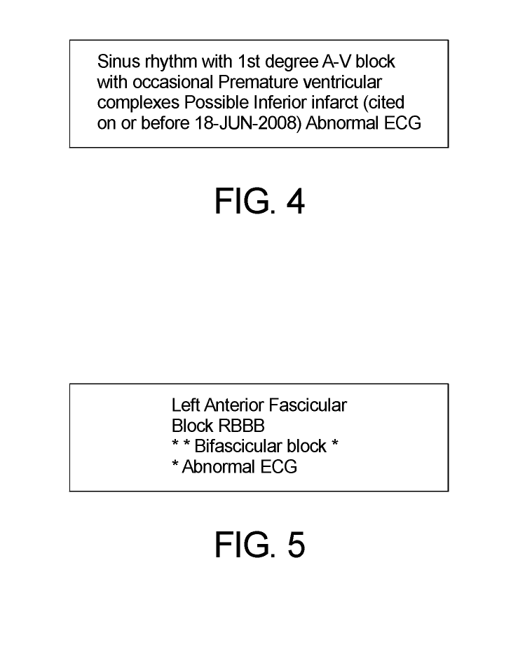

FIG. 4 illustrates a real-world example of interpretation notes 152 to help illustrate the task. In the example shown in FIG. 4, periods are not used to separate phrases. Rather, the healthcare provider typically strikes the return key at the end of the line to begin a new phrase. In the first line of this example, the return key was pressed after the word “occasional” although the next word “Premature” was part of the same phrase. Additionally, the word “Premature” is capitalized, which would seem to hint a new phrase was starting. However, the charge capture system 100 can determine the relationship between the words “occasional” and “premature.” It properly deduces that these words belong together and effectively determines the first two lines form a single phrase.

In the next step of the code generation method, the interpretation notes 152 of the study field 154 is examined by performing fuzzy logic matching of words and an initial batch of codes generated. Once the initial batch of codes has been determined, the next step includes combining or eliminating some of the codes. The step may be accomplished by: scanning every phrase in the study, and, for each phrase, processing the phrase through a pattern matcher that attempts to match elements of the phrase to a code. Every known diagnostic code may be checked against the phrase and thus zero, one, or a plurality of codes may result from each phrase. The pattern matcher may operate based on clinical knowledge and statistical sampling of a large body of studies, including supervised learning, manual coding examples, and dictionary mapping of phrases to codes.

As an example, ICD-10-CM code 144.1 represents a heart condition defined as “Atrioventricular block, second degree.” Clinically, this represents a condition where the electrical signals between the top half (atria) and the bottom half (ventricles) of the heart do not conduct normally. In physician's notes, however, it is not common for the physician to use the term “Atrioventricular block, second degree.” Instead, the physician will commonly use phrases like “2^{nd} degree AV block” or “2:1 block” or “Wenckebach” or “Mobitz.” In an embodiment, the charge capture system includes 16 possible word patterns that result in this code.

The pattern matcher 114 may also look for certain words that indicate some degree of ambiguity or fuzziness. For example, if the physician's notes indicate “possible infarct” then the word “possible” indicates a degree of uncertainty. The charge capture system 100 may use this information to adjust the confidence level of the generated code.

The definition of each code may also contain a clinical priority value to rank the code relative to other diagnosis codes. For example, infarcts (damaged heart muscle) are far more significant than tachycardia (fast heart beat). Thus, when a code related to infarct is generated by charge capture system, the code is assigned a high clinical priority value or rank.

The ICD standards define many rules that are followed throughout the healthcare industry, specifically identifying when a code may and may not be used. The charge capture system factors these rules into its algorithms, eliminating codes that are ineligible. The charge capture system can also detect forms of code duplication that are often not obvious.

For example, consider the example interpretive notes provided in FIG. 5. The first phrase, “Left Anterior Fascicular Block,” results in an interim code of I44.4 being generated. The second phrase, “RBBB,” is an acronym for Right Bundle Branch Block, which results in a code of I45.10 being generated. The third phrase, “Bifascicular Block” is a clinical condition defined as both LAFB and RBBB. Thus, it is appropriate to only report ICD-10-CM code 145.2 “Bifascicular Block” to cover all three phrases. The initial pattern matching stage generates separate codes for each of the first three phrases, and the subsequent matching stage that matches the diagnosis code to the procedural code eliminates the duplicative or lower ranked codes. The refined list of codes is then placed into the outgoing relative database table for processing by the interface engine 112.

If there is more than one diagnosis, multiple possible codes may be identified. In one embodiment, the charge capture system 100 prioritizes the codes by highest clinical significance based on selected criteria such as the critical nature of the procedure and/or the costs associated with the procedure. By prioritizing codes based on the highest clinical significance, public and private insurers 50, such as Medicare, may set reimbursement levels based on the critical nature of the patient. In some embodiments, only the most clinically significant diagnostic code is provided to the public or private insurer's billing servers. Additionally, when prioritizing codes, the charge capture system 100 may validate the initial batch of codes to ensure that the procedure code/purpose of the test used is billable.

Billing codes 108 generated by the charge capture system 100 may be generated in a real-time mode and be immediately provided to the appropriate billing systems 110 of the public and private insurers 50. This real-time mode permits a medical facility to bill for services immediately upon completion of electronic orders submitted by the healthcare provider through the EMR, HIS, or other input data source without requiring that the patient be discharged before starting the billing process.

The following example is provided as a hypothetical to illustrate the methodology. A patient undergoes a 12-lead electrocardiogram (“ECG”) exam. The healthcare provider enters the medical procedure into the EMR system, which identifies the following codes: a CPT code of 93000 (Electrocardiogram with Interpretation and Report), an ICD-9 code of 4A02X4Z, and an ICD-10 code of 89.52. The results from the tests as detected by the ECG and confirmed by the healthcare provider in the diagnostics study management system reveal that the patient has various cardiac problems including a pacemaker, a left-axis deviation, a non-specific intraventricular block, and a history of a prior inferior and anterolateral infarct. Overall, the conclusion from these test results is that the patient has an abnormal ECG. By processing the test results in the decoding and matching engine, the capture charge system generates the following codes: ICD-9 codes of 410.7, 426.6, 794.31, V45.01 and ICD-10 codes of I21.4, I45.4, R94.31, and Z95.0. Referring to FIG. 3, the user interface 150 of the charge capture system 100 illustrates the possible interpretation notes 152 that apply to the hypothetical situation described above.

Text interpretation notes are just one example of many possible embodiments of interpretation notes. For example, interpretation notes 152 may be provided by voice recognition, for example, by using a third-party voice-recognition software program to capture dictation and convert the voice responses into text. This input format is used by physicians in lieu of utilizing a keyboard or other input source to type in the information.

In a further embodiment, the charge capture system 100 provides an alert to the receiving data system, such as a billing system or an EMR, that a billing code is validated or approved. The charge capture system 100 may include a reason or explanation that the billing code is an acceptable code for medical reimbursement. Validation of a billing code may include providing a Boolean type response if the medical procedural code matches the input data. If the billing code is not validated, the charge capture system may be configured to provide a substitute medical procedural code from the list which more closely matches.

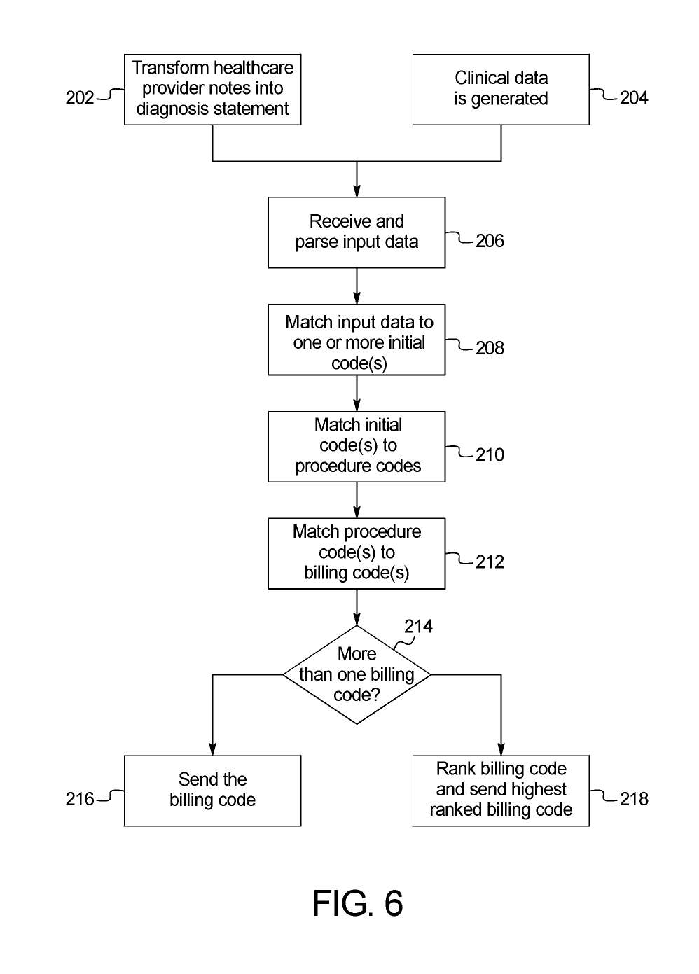

In one embodiment, the charge capture system 100 may execute a method 200 of generating medical billing codes as shown in FIG. 6. In the illustrated embodiment, the first two steps 202, 204 of the method prepare and format information into input data 102. As noted above, the input data source 104 may include a study management system, digital medical device, electronic medical record database, or any other source of clinical data. The healthcare provider notes are transformed into diagnosis statements in step 202, and clinical or input data is generated in step 204. In the next step 206, the charge capture system receives and parses the input data. The charge capture system then matches the input data to one or more initial codes in step 208, which may then matched to procedure codes in step 210.

Finally, the procedure codes are matched to billing codes in step 212. At step 214, the charge capture system determines if more than one billing code has been generated. If only a single billing code is generated, the billing code is sent to the billing systems, the EMR systems, and any other system as requested by the user through the charge capture system in step 216. If more than one billing code is generated, the charge capture system ranks the billing codes according to any number of selected factors such as the critical nature of the procedure and/or the costs associated with the procedure in step 218. The charge capture system then sends the highest ranked billing code to the billing systems, the EMR systems, and any other system as requested by the user through the charge capture system in step 218 as well.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method for coding clinical input data by a charge capture system, comprising the steps of:
receiving clinical input data from a clinical input data source, the clinical input data including interpretations of measured data;
dividing the interpretations of measured data into one or more phrases;
matching each phrase to an initial code;
processing the initial codes to generate a corresponding one or more billing codes;
if more than one billing code is determined, ranking the billing codes in an order of significance to determine a highest ranked billing code; and
providing one of the one billing code and the highest ranked billing code to a billing system.

2. The method of claim 1, wherein the step of processing the initial codes includes the steps of deleting duplicative codes, ineligible codes, and codes that conflict.

3. The method of claim 1, further comprising the step of assigning a confidence level to each billing code.

4. The method of claim 3, further comprising the steps of assessing an ambiguity level for each code and adjusting the respective confidence level of a code if ambiguity is detected.

5. The method of claim 1, wherein the step of dividing the interpretations of measured data into one or more phrases includes the steps of:
examining punctuation, characters, and word casing to develop interpretations data; and
comparing the interpretations data to a plurality of word pairing statistics.

6. The method of claim 1, wherein the ranking of the billing codes is generated by ranking codes according to the reimbursement amount for each code being ranked.

7. A system for the automatic real-time generation of medical billing codes, comprising:
a controller in communication with one or more clinical data input sources;
a database including a plurality of medical code information; and
a memory coupled to the controller configured to store program instructions executable by the controller, that, when executed, cause the controller to:
receive an electronic order identifying a medical procedure for a patient and including first clinical input data from a first clinical data input source;
receive second clinical input data including one of physiological data of the patient, medical device-generated interpretive statements, and healthcare provider-generated interpretive statements from a second clinical data input source;
normalize the interpretive statements of the second clinical input data based on a built-in data dictionary;
map the normalized interpretive statements into one or more initial codes of a structured data format, wherein each code uniquely identifies a medical condition;
generate one or more medical billing codes that correspond to the medical condition based on definitions provided in the database;
process the billing codes to remove redundant codes and conflicting codes to generate one or more final billing codes; and
transmit the one or more final billing codes to a receiving data system and/or electronic billing system.

8. The system of claim 7, further including the step of providing an alert to the receiving data system that a billing code is validated and providing a reason that the billing code is an acceptable code for medical reimbursement.

9. The system of claim 8, further comprising the step of validating that a billing code corresponds with a list of reimbursable reasons includes the steps of:
providing a Boolean type response if the medical procedural code matches; and
providing a substitute medical procedural code from the list which more closely matches.

10. The system of claim 7, further comprising a dictionary on the database including a table of interpretive statements and a table of medical billing codes, wherein the interpretive statements can be matched to the medical billing codes from the data dictionary.

11. The system of claim 7, wherein the medical device-generated interpretive statements contain verbiage, abbreviations, and acronyms of diagnosis relative to the procedure performed on the patient.

13. The system of claim 7, wherein the step of normalizing the interpretive statements include the steps of:
parsing the text of interpretive statements into one or more substrings; and
identifying one or more codes of a structured data format that correspond to the one or more substrings; and
if more than one code is identified, prioritizing the codes.

14. The system of claim 7, further comprising the step of generating a formatted data file containing the matching one or more code or codes.

15. The system of claim 7, wherein the receiving data system comprises an electronic medical record software.
